(19) United States
(12) Patent Application Publication
(10) Pub. No.: US 2009/0073283 A1
(43) Pub. Date: Mar. 19, 2009

(54) METHOD AND APPARATUS FOR CAPTURING IMAGES

(75) Inventor: Benjamin Young, Colorado Springs, CO (US)

Correspondence Address: SCHWEGMAN, LUNDBERG & WOESSNER / ATMEL, P.O. BOX 2938, MINNEAPOLIS, MN, 55402, US

(73) Assignee: ATMEL CORPORATION, San Jose, CA (US)

(21) Appl. No.: 11/856,796

(22) Filed: Sep. 18, 2007

(51) Int. Cl. H04N 5/76

(52) U.S. Cl. 348/231.99; 348/E05.024

(57) ABSTRACT

In a production system including a plurality of imaging devices associated with a respective production tool, an image capture unit, a controller, and an image storage unit, an image capturing method and apparatus is disclosed. The imaging device records the image and transmits the image to the image capture unit. The image capture unit processes the received image and stores the processed image in the image storage unit.

### FIELD OF INVENTION

The present invention is related to capturing images.

### BACKGROUND

In a manufacturing process, there are often multiple stages of production. Accordingly, quality control should be performed at each stage in order to ensure a quality final product. In a production line for an integrated circuit (IC), and the like, these stages may include layering stages for the IC, where each layering stage may be performed at a different tool.

One solution to performing quality control for the process is for an imaging device to record an image of the layer at each tool for analyzing at a later time. The imaging device, which may be a camera or microscope, can be attached to a printer so that the imaging device can transfer the recorded image to the printer for printing. Once the image is printed, the printout is scanned on a scanner into a computer where the image file may be accessed and analyzed remotely.

The drawback, however, is that a printer, scanner and computer are needed at each tool in order to analyze an image recorded from that tool. Having multiple groups of expensive equipment tends to be costly and inefficient. Additionally, the technique requires that an individual perform the additional step of scanning in an already printed image in order to provide it for analysis later.

### SUMMARY

An image capturing method and apparatus are disclosed for use in connection with a production system including a plurality of imaging devices associated with a respective production tool, an image capture unit, a controller, and an image storage unit. The image capturing method includes selecting an imaging device to record an image. The imaging device records the image and transmits the image to the image capture unit. The image capture unit processes the received image and stores the processed image in the image storage unit.

### BRIEF DESCRIPTION OF THE DRAWINGS

A more detailed understanding of the invention may be had from the following description, given by way of example and to be understood in conjunction with the accompanying drawings wherein:

FIG. 1 is a block diagram of an imaging system including an image capture unit, a controller, an image storage unit, and a plurality of imaging devices in accordance with an embodiment of the invention;

FIG. 2 is a functional block diagram of the image capture unit of FIG. 1; and

FIG. 3 is a flow diagram of an image capturing and storing embodiment.

### DETAILED DESCRIPTION OF EXEMPLARY EMBODIMENTS

The present invention will be described with reference to the figures wherein like numerals represent like elements throughout.

The Imaging System

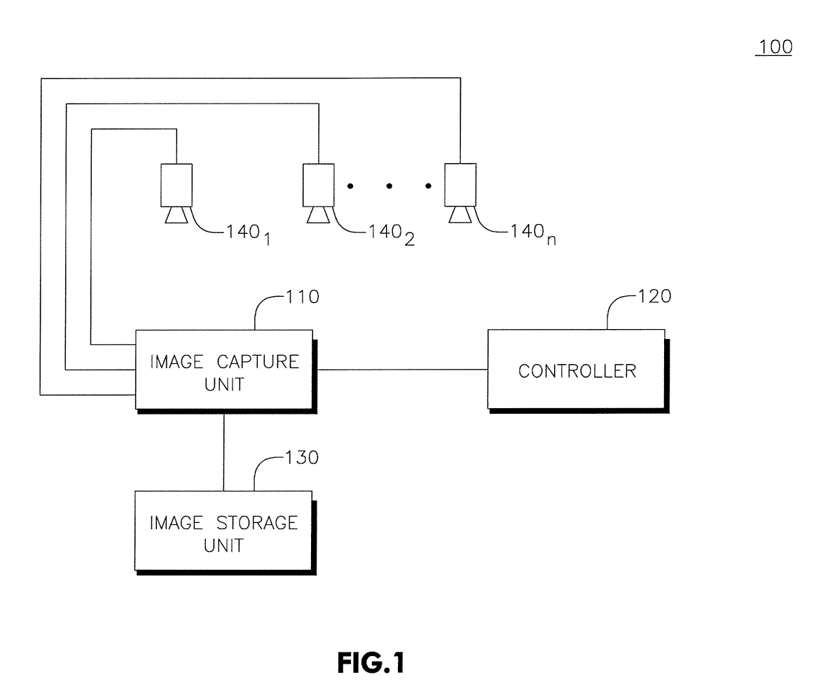

In accordance with an embodiment of the invention, FIG. 1 is a block diagram of an imaging system 100 including an image capture unit 110, a controller 120, an image storage unit 130, and a plurality of imaging devices 140 (designated 140₁, 140₂, . . . , 140ₙ). As shown in FIG. 1, the image capture unit 110 is in communication with the plurality of imaging devices 140, the controller 120 and the image storage unit 130. Although communication between the image capture unit 110, the controller 120, the image storage unit 130 and the plurality of imaging devices 140 is shown as being wired, it may also be wireless communication or a combination of wired and wireless communication.

The imaging devices 140 may include cameras, microscopes, and the like, and are implemented to record an image, or a video, at a particular location where the particular imaging device 140 is located. For example, in a manufacturing process for ICs, one imaging device 140 may be located at a processing tool (not shown) where one layering operation occurs, while other imaging devices 140 are located at other processing tool locations to record images of layering operations at those tools. Through the connection with the image capture unit 110, the imaging devices 140 are capable of transferring the images recorded at their respective locations to the image capture unit 110.

The image capture unit 110, which will be described in further detail below, is configured to receive images from the plurality of imaging devices 140 and perform processing and storage on the received images. In addition, the image capture unit 110 signals the individual imaging devices 140 to record an image and transfer the image to the image capture unit 110, where the image can be processed and stored for later analysis.

The controller 120 communicates with the image capture unit 110, and instructs the image capture unit 110 regarding which imaging device 140 will be used to capture and store an image. The controller 120 may operate automatically, or may include an operator determining which imaging device 140 will record and transfer an image.

The image storage unit 130 is adapted to receive processed images from the image capture unit 110 and store them for later analysis. In FIG. 1, the image storage unit 130 is shown as external to the image capture unit 110. However, the image storage unit 130 may also be integrated within the image capture unit 110, such as a memory card, (e.g., USB attached storage device, and the like). Additionally, the image storage unit 130 may be connected to a network so that images on it may be accessed and analyzed remotely. For example, the image storage unit 130 in one embodiment may be a web-server that can be accessed via the Internet.

Image Capture Unit

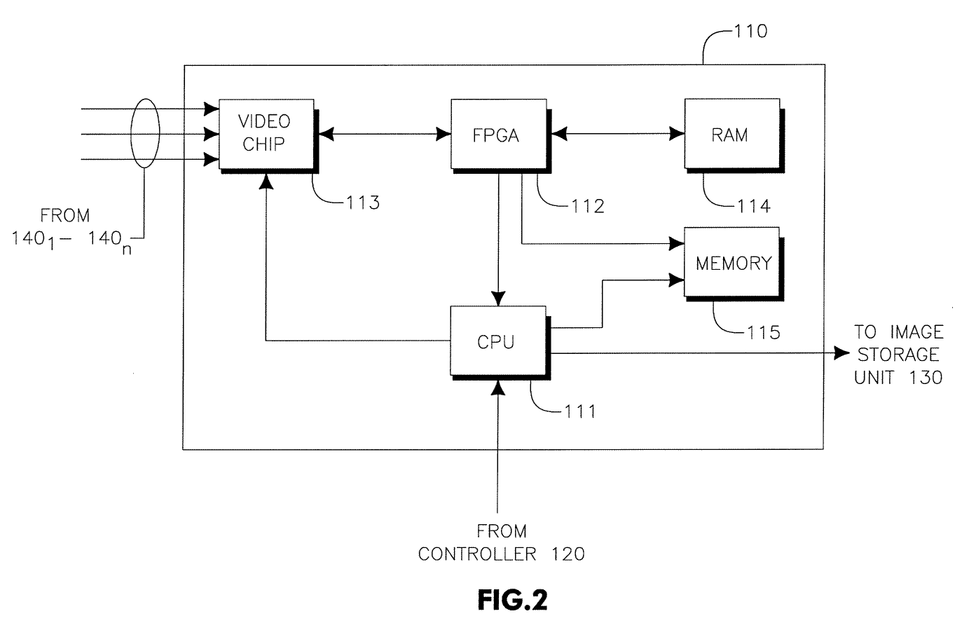

FIG. 2 is a functional block diagram of the image capture unit 110 of FIG. 1. The image capture unit 110 includes a central processing unit (CPU) 111, a field programmable gate array (FPGA) 112, a video chip 113, a static random access memory (RAM) 114, and a memory device 115. As shown in FIG. 2, the CPU 111 is in communication with the FPGA 112, the video chip 113, the memory device 115, and devices external to the image capture unit 110, such as the controller 120 and the image storage unit 130. The FPGA 112 is in communication with the CPU 111, the video chip 113, the static RAM 114, and the memory device 115. The video chip 113 receives the transferred images from the plurality of external imaging devices 140 in addition to being in communication with the FPGA 112 and CPU 111.

In another embodiment, the video chip 113 receives a transferred image from a particular imaging device 140. The video chip transfers the image to the FPGA 112 where the image is captured and may be stored in the static RAM 114. The FPGA 112 is configured to transfer the captured image to the CPU 111 where the image may be processed. The CPU 111 may then transfer the processed image to the image storage unit 130 where it may be accessed and analyzed.

In addition, the CPU 111 receives instructions from the controller 120 regarding particular imaging devices 140 from which to capture images. The CPU 111 instructs the particular imaging devices 140, via the video chip 113, to record and transfer the images to the image capture unit 110.

Image Capturing and Storing Method

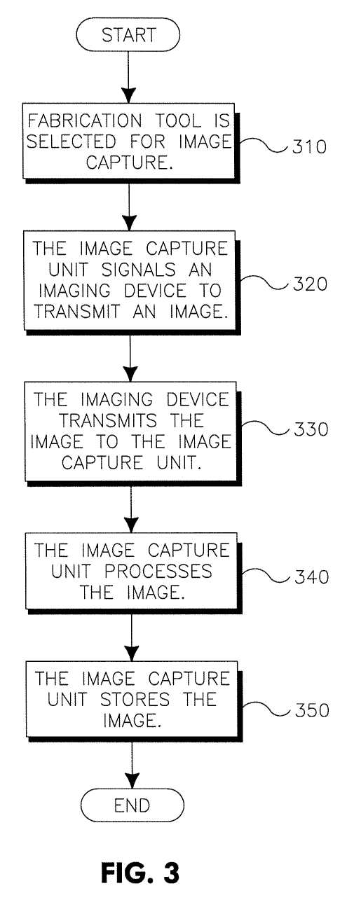

FIG. 3 is a flow diagram of an image capturing and storing method 300. In step 310, a particular fabrication tool is selected for an image capture. In an embodiment, the controller 120 signals the CPU 111 of the image capture unit 110 to inform the CPU 111 regarding which fabrication tool is have an image (or video) stored and captured from it. Alternatively, the controller 120 may signal the CPU 111 of the image capture unit 110 to inform the CPU 111 of the particular port from which to capture an image, where a particular port on the video chip 113 is associated with a particular imaging device 140.

The controller 120 may be configured to operate automatically, such as selecting a particular tool during a pre-defined time of the fabrication process, or the controller 120 may be utilized to manually signal the image capture unit 110. For example, an operator at a particular fabrication tool may determine that an image capture should occur. Consequently, the operator may manually control the controller 120 to instruct the image capture unit 110 to capture a layering image at his or her fabrication tool.

The image capture unit 110 signals the selected imaging device 140 to record and transmit an image, which may be in the form of a video, to the image capture unit 110 (step 320). In one example, the CPU 111 of the image capture unit 110 instructs the video chip 113 to direct the selected imaging device 140 to record and transmit the image. The selected imaging device 140 then records and transmits the image to the image capture unit 110 (step 330), and more particularly to the video chip 113 of the image capture unit 110 on a pre-defined port, or channel. This may include the video chip 113 receiving the image from the selected imaging device 140 and transferring the image to the FPGA 112, which stores the image in the static RAM 114, and alerts the CPU 111 that the image has been captured.

After the image is captured, the image capture unit 110 processes the image (step 340). In one embodiment, the image is compressed, for example into a Joint Photographic Experts Group (JPEG) standard format, with the CPU 111 performing the compression, where the compression processing may include, for example, discrete cosine transform (DCT) processing or fast fourier transform (FFT) processing. Alternatively, the compression may be performed by the FPGA 112, where the FPGA 112 signals to the CPU 111 when the compression is complete. In yet another alternative to step 340, the CPU 111 may perform partial processing, such as processing the image header, footer, and performing cell assembly, (e.g., joining image cells into a JPEG output), while instructing the FPGA 112 which cells to compress. It should be noted that the step of processing (step 340) may be performed after receiving only one image from a selected imaging device 140, or may be performed after a plurality of images have been received.

After processing, the image capture unit 110 stores the processed image (step 350). In one embodiment, the CPU 111 of the image capture unit 110 may store the image locally in a local memory unit, such as memory unit 115. Alternatively, the CPU 111 may store the processed image by transferring it to the external image storage unit 130. In this manner, the processed image may be analyzed for purposes of, for example, quality control.

Although the features and elements of the present invention are described in the exemplary embodiments in particular combinations, each feature or element can be used alone without the other features and elements of the exemplary embodiments or in various combinations with or without other features and elements of the present invention. The present invention may be implemented in a computer program or firmware tangibly embodied in a computer-readable storage medium having machine readable instructions for execution by a machine, a processor, and/or any general purpose computer for use with or by any non-volatile memory device. Suitable processors include, by way of example, both general and special purpose processors.

Typically, a processor will receive instructions and data from a read only memory (ROM), a RAM, and/or a storage device having stored software or firmware. Storage devices suitable for embodying computer program instructions and data include all forms of non-volatile memory, including by way of example semiconductor memory devices, read only memories (ROMs), magnetic media such as internal hard disks and removable disks, magneto-optical media, and optical media such as CD-ROM disks and digital versatile disks (DVDs). Types of hardware components, processors, or machines which may be used by or in conjunction with the present invention include Application Specific Integrated Circuits (ASICs), Field Programmable Gate Arrays (FPGAs), microprocessors, or any integrated circuit.

What is claimed is:

1. In a production system including a plurality of imaging devices associated with a respective production tool, an image capture unit, a controller, and an image storage unit, an image capturing method, the method comprising:
(a) selecting at least one imaging device to record an image;
(b) the at least one imaging device recording the image and transmitting the image to the image capture unit;
(c) the image capture unit compressing the received image; and
(d) the image capture unit storing the compressed image in the image storage unit.

2. The method of claim 1 wherein the imaging device includes a camera.

3. The method of claim 1 wherein the imaging device includes a microscope.

4. The method of claim 1 wherein the image includes a video.

5. The method of claim 1 wherein step (a) further comprises:
(a1) the controller signaling to the image capture unit which imaging device to select to record the image; and
(a2) the image capture unit instructing the selected imaging device to record and transmit the image to the image capture unit.

6. The method of claim 5 wherein the controller signal to the image capture unit in step (a1) is automated.

7. The method of claim 5 wherein the controller signal to the image capture unit in step (a1) is manually controlled.

8. The method of claim 1 wherein step (c) includes:
(c1) performing a transform on the received image.

9. The method of claim 8 wherein step (c1) includes:
(c2) performing a fast fourier transform (FFT) on the received image.

10. The method of claim 8 wherein step (c1) includes:
(c2) performing a discrete cosine transform (DCT) on the received image.

11. The method of claim 1 wherein the image storage device is locally integrated to the image capture unit.

12. The method of claim 11 wherein the image storage device is a memory card.

13. The method of claim 11 wherein the image storage device is a universal serial bus (USB) storage device.

14. The method of claim 1 wherein the image storage device is located remote to the image capture unit.

15. The method of claim 14 wherein the image storage device is a web-server.

16. The method of claim 1, further comprising:
(e) remotely accessing the image stored on the image storage device.

17. In a production system including a plurality of imaging devices associated with a respective production tool, an image capture unit, a controller, and an image storage unit, the image capture unit comprising:
a central processing unit (CPU);
a field programmable gate array (FPGA) in communication with the CPU;
a video chip in communication with the FPGA and the CPU; and
a static random access memory (RAM); and
wherein the CPU is configured to receive a signal from the controller indicating a selected imaging device from which to record and capture an image, the CPU instructing the video chip to signal the selected imaging device to record and transmit an image to the video chip, and
wherein the video chip is configured to receive the image from the selected imaging device and transfer the image to the FPGA, and
wherein the FPGA processes the image, and wherein the CPU stores the processed image on the image storage device.

18. The image capture unit of claim 17 wherein the FPGA performs compression upon the received image.

19. The image capture unit of claim 17 wherein the CPU performs a fast fourier transform (FFT) on the received image.

20. The image capture unit of claim 17 wherein the CPU performs a discrete cosine transform (DCT) on the received image.

21. The image capture unit of claim 17 wherein the FPGA performs a fast fourier transform (FFT) on the received image.

22. The image capture unit of claim 17 wherein the FPGA performs a discrete cosine transform (DCT) on the received image.

23. The image capture unit of claim 17 wherein the CPU performs compression upon the received image.

24. The image capture unit of claim 17 wherein the image storage device is local to the image capture unit.

25. The image capture unit of claim 17 wherein the image storage device is located remotely to the image capture unit.

26. The image capture unit of claim 25 wherein the image storage device is a web-server.

27. The image capture unit of claim 17 wherein a stored image is accessible remotely.

28. An image capturing system, comprising:
a plurality of imaging devices configured to record and transmit images;
an image capture unit comprising:
a central processing unit (CPU);
a field programmable gate array (FPGA) in communication with the CPU;
a video chip in communication with the FPGA and the CPU; and
a static random access memory (RAM); and
wherein the CPU is configured to receive a signal indicating a selected imaging device from which to record and capture an image, the CPU instructing the video chip, in communication with the plurality of imaging devices, to signal the selected imaging device to record and transmit an image to the video chip, and
wherein the video chip is configured to receive the image from the selected imaging device and transfer the image to the FPGA, and
wherein the FPGA processes the image, and wherein the CPU stores the image;
a controller in communication with the CPU of the image capture unit, the controller configured to generate the signal indicating the selected imagining device and transmit the signal to the CPU; and
an image storage device in communication with the CPU of the image capture unit, the image storage device configured to receive the image from the CPU and store the image, and wherein the stored image is remotely accessible on the image storage device.
